(19) United States
(12) Patent Application Publication
(10) Pub. No.: US 2006/0021537 A1
(43) Pub. Date: Feb. 2, 2006

(54) Curing method of cure type liquid composition and inkjet recording apparatus

(76) Inventors: Kazuhiko Ohtsu, Mishima-shi (JP); Toru Ushirogouchi, Yokohama-shi (JP); Ryozo Akiyama, Mishima-shi (JP); Hiroshi Kiyomoto, Hiratsuka-shi (JP); Mitsuru Ishibashi, Yokohama-shi (JP); Masashi Hiroki, Yokohama-shi (JP); Yukiko Kawakami, Mishima-shi (JP)

Correspondence Address: HARNESS, DICKEY & PIERCE, P.L.C., P.O. BOX 828, BLOOMFIELD HILLS, MI, 48303, US

(21) Appl. No.: 11/172,710

(22) Filed: Jul. 1, 2005

(30) Foreign Application Priority Data
Jul. 29, 2004 (JP) 2004-222191

(51) Int. Cl. B41F 23/04

(52) U.S. Cl. 101/487

(57) ABSTRACT

There is proposed a method of curing an electromagnetic radiation-curing type liquid composition comprising a solvent polymerizable in the presence of an acid, and a photo-acid generating agent which is dissolved in the solvent and capable of generating the acid when irradiated with electromagnetic radiation. This method comprises forming a layer of the electromagnetic radiation-curing type liquid composition on a recording medium, and irradiating electromagnetic radiation including a wavelength which can be absorbed by the photo-acid generating agent onto the composition layer to generate the acid from the photo-acid generating agent, thereby curing the composition layer, which is characterized in that the recording medium is heated on the occasion of forming the layer of the electromagnetic radiation-curing type liquid composition in such a manner that the temperature of the recording medium is increased higher than the temperature of the electromagnetic radiation-curing type liquid composition being delivered onto the recording medium.

### CROSS-REFERENCE TO RELATED APPLICATIONS

This application is based upon and claims the benefit of priority from prior Japanese Patent Application No. 2004-222191, filed Jul. 29, 2004, the entire contents of which are incorporated herein by reference.

### BACKGROUND OF THE INVENTION

1. Field of the Invention

This invention relates to a method of curing an electromagnetic radiation-curing type liquid composition which is curable by an acid generated from the irradiation of the ink composition by electromagnetic radiation. This invention also relates to an inkjet recording apparatus.

2. Description of the Related Art

In recent years, since it is possible to quickly cope with increasingly versatile needs and to reduce the quantity of stocks, on-demand printers are now increasingly employed. As specific examples of an on-demand printer, an electrophotographic printer which employs a toner or a liquid toner as well as an inkjet printer which is capable of achieving high-speedy and high-quality printing are expected to be useful. In the case of the inkjet printer, a solvent-type ink can be handled in a closed system until the ink is delivered to a printing surface (i.e. a surface to be printed). The ink to be employed therein is required to be sufficiently fluid for delivery, so that the concentration of the solvent in the ink is required to be sufficiently increased. Therefore, it is difficult, in the case of this solvent type ink, to solve the problem of pollution of the atmosphere by an organic solvent. Further, in the case of this solvent type ink, there is a possibility of generating a degraded printed surface which may occur in the process of drying the ink layer, thereby making it not necessarily easy to obtain printed matter of high quality.

With a view to solving the aforementioned problem originating from the employment of an organic solvent, there has been proposed the employment of an ink that can be cured by UV irradiation (hereinafter referred to as UV ink) and a printer system using the UV ink. As for the UV ink, one of representative examples thereof includes one comprising a radically polymerizable monomer, a photopolymerization initiator, and a pigment. According to this printer system using the UV ink, the UV ink that has been delivered onto a printing surface can be quickly photo-cured. Since the ink layer can be instantaneously non-fluidized as described above, it is possible to obtain printed matter of relatively high quality. Ordinary UV inks however are accompanied with a problem that if a printing surface is formed of an absorptive medium, it is difficult to quickly cure the UV ink existing deep inside the absorptive printing matter.

Recently, there has been proposed an inkjet recording apparatus which comprises an inkjet recording head for delivering an ink onto a recording medium to form an ink layer; means for transferring the recording medium; a light source for irradiating light onto the ink layer; and heating means for heating the ink layer. In the recording process using this recording apparatus, a photo-curable inkjet ink is employed, the photo-curable inkjet ink comprising a photo-acid generating agent which is capable of generating the acid as it is irradiated with electromagnetic radiation, a colorant component, and a solvent which is polymerizable in the presence of an acid, and electromagnetic radiation is irradiated onto the ink layer formed on the surface of a recording medium. As a result, an acid is generated from the photo-acid generating agent in the ink and this acid then diffuses into the ink layer as the ink layer is heated. Thus, the acid acts as a catalyst for the polymerization reaction of the ink, thereby making it possible to cure even the ink that has penetrated deep into the absorptive paper. However, this inkjet recording apparatus is accompanied with a problem that it is required to separately install a large heating means which is much larger in scale than that to be employed in an inkjet recording apparatus using the ordinary ink (acrylic photo-curable inkjet ink).

Since the acrylic photo-curable inkjet ink is higher in viscosity at normal temperature than that of the ordinary inkjet ink, a heating means is required to be installed at a supply passageway for feeding the UV ink into the recording head in order to lower the viscosity of the UV ink so as to enable the UV ink to be stably discharged. Further, there is also known an inkjet recording apparatus which is provided with a recording medium temperature-detecting means for detecting the temperature of a recording medium and with a recording medium temperature-controlling means for controlling the temperature of the recording medium to a target temperature, thereby making it possible to adjust the spreading of each dot on the recording medium which can be formed by a droplet of ink, thus ensuring high quality printing.

Moreover, there is also known an inkjet recording apparatus which is provided with a recording medium-selecting means for enabling printing to be performed on various kinds of recording mediums, with an inkjet nozzle temperature-controlling means, and a recording medium temperature-controlling medium, thereby making it possible to adjust the conditions suited to the recording medium, i.e., to adjust the temperature of ink as well as the temperature of the recording medium, thus ensuring high quality printing.

### BRIEF SUMMARY OF THE INVENTION

Since the conventional inkjet recording apparatuses mentioned above require a large scale heating means for heating the recording medium and the liquid composition for the UV ink, it is impossible to prevent the recording apparatus from becoming very large in scale. Further, the heat to be irradiated from the light-irradiating means together with electromagnetic radiation such as ultraviolet rays as well as the heat from the heating means cannot necessarily be effectively utilized, thus allowing these heats to be taken away by the recording medium or the transferring means. As a result, it would be impossible to sufficiently heat the ink layer to enable the curing of the UV ink, thus resulting in insufficient heating. In that case, the diffusion of the acid which is deemed to be the lifeline of the chemical amplification mechanism of ink cannot be sufficiently executed, thus giving rise to insufficient curing of the ink.

An object of the present invention is to provide a method of effectively curing an electromagnetic radiation-curing type liquid composition comprising a solvent which is polymerizable in the presence of an acid, and a photo-acid generating agent which is dissolved in the solvent and capable of generating the acid as it is irradiated with electromagnetic radiation.

Another object of the present invention is to provide an apparatus which is capable of discharging an electromagnetic radiation-curing type liquid composition by inkjet so as to effectively perform recording, wherein the ink composition comprises a solvent which is polymerizable in the presence of an acid, and a photo-acid generating agent which is dissolved in the solvent and capable of generating the acid as it is irradiated with electromagnetic radiation.

According to one aspect of the present invention, there is provided a method of curing an electromagnetic radiation-curing type liquid composition comprising a solvent which is polymerizable in the presence of an acid, and a photo-acid generating agent which is dissolved in the solvent and capable of generating the acid as it is irradiated with electromagnetic radiation, the method comprising: forming a layer of the electromagnetic radiation-curing type liquid composition on a recording medium; and irradiating electromagnetic radiation including a wavelength which can be absorbed by the photo-acid generating agent onto the layer of the electromagnetic radiation-curing type liquid composition to generate the acid from the photo-acid generating agent, thereby curing the layer of the electromagnetic radiation-curing type liquid composition; wherein the recording medium is heated on the occasion of forming the layer of the electromagnetic radiation-curing type liquid composition in such a manner that the temperature of the recording medium is increased higher than the temperature of the electromagnetic radiation-curing type liquid composition being delivered onto the recording medium.

According to another aspect of the present invention, there is provided an inkjet recording apparatus comprising: a delivering means delivering an electromagnetic radiation-curing type liquid composition onto the recording medium by an inkjet recording head, the ink composition comprising a solvent which is polymerizable in the presence of an acid, and a photo-acid generating agent which is dissolved in the solvent and capable of generating the acid as it is irradiated with electromagnetic radiation; a transferring means moving the recording medium and the inkjet recording head relative to each other; a heat source heating the recording medium at least until the ink composition is delivered from the inkjet recording head; and an irradiation source irradiating electromagnetic radiation including a wavelength that can be absorbed by the photo-acid generating agent to the electromagnetic radiation-curing type liquid composition that has been heated by the heat source.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram schematically illustrating the inkjet recording apparatus according to one embodiment of the present invention;

FIG. 2 is a block diagram schematically illustrating the inkjet recording apparatus according to another embodiment of the present invention;

FIG. 3 is a block diagram schematically illustrating the inkjet recording apparatus according to a further embodiment of the present invention;

FIG. 4 is a plan view schematically illustrating a non-contact type converging halogen heater employed in the inkjet recording apparatus shown in FIG. 2;

FIG. 5 is a block diagram schematically illustrating the inkjet recording apparatus according to a further embodiment of the present invention;

FIG. 6 is a block diagram schematically illustrating the inkjet recording apparatus according to a further embodiment of the present invention;

FIG. 7 is a block diagram schematically illustrating the inkjet recording apparatus according to a further embodiment of the present invention;

FIG. 8 is a block diagram schematically illustrating the inkjet recording apparatus according to a further embodiment of the present invention; and

FIG. 9 is a block diagram schematically illustrating the inkjet recording apparatus according to a further embodiment of the present invention.

### DETAILED DESCRIPTION OF THE INVENTION

Next, various embodiments of the present invention will be explained.

In the method according to one embodiment of the present invention, there is employed an electromagnetic radiation-curing type liquid composition comprising a solvent which is polymerizable in the presence of an acid, a photo-acid generating agent which is capable of generating the acid as it is irradiated with light. The image-forming capability of this kind of liquid composition depends largely on the chemically amplification mechanism thereof. Namely, at first, when the liquid composition is irradiated with electromagnetic radiation such as ultraviolet rays (irradiation of light), an acid is generated from the photo-acid generating agent and this acid then diffuses into the layer of electromagnetic radiation-curing type liquid composition due to the heating thereof, thus the acid acts as a catalyst for the cross-linking reaction of the acid-polymerizable solvent. In this case, the electromagnetic radiation to be irradiated includes a wavelength that can be absorbed by the photo-acid generating agent. Due to this diffusion of the acid, it is now possible to enable the acid to penetrate even into the deep region of the layer to which the light is incapable of being transmitted due to the obstruction by the coloring materials for example, thus making it possible to promote the curing throughout an extensive region of the layer.

In the curing method according to one embodiment of the present invention in particular, it is desirable that the viscosity of the liquid composition such as ink is adjusted to a predetermined value in order to enable the liquid composition to be stably delivered from a recording head. Specifically, it is desirable that the liquid composition has a fluidity which is confined within a predetermined range at normal temperature. For example, the viscosity of the liquid composition should be 50 cp or less, more preferably 30 cp or less at a temperature of 25° C.

In the liquid composition to be employed in the method according to one embodiment of the present invention, the solvent thereof which is polymerizable in the presence of an acid can be formed of at least one kind of compound selected from the group consisting of epoxy compounds having an alicyclic skeleton and/or an aliphatic skeleton, vinyl ether compounds, oxiran group-containing compound and oxetane ring-containing compound. In particular, an acid-polymerizable compound having an alicyclic skeleton and/or an aliphatic skeleton and exhibiting a viscosity of not more than 50 mPa.s at ordinary temperature and ordinary pressure and a boiling point of not less than 150° C. is preferable for use as an acid-polymerizable solvent.

As for the photo-acid generating agent, it is possible to employ, for example, onium salts, diazonium salts, quinone diazide compounds, organic halides, aromatic sulfonate compounds, bisulfone compounds, sulfonyl compounds, sulfonate compounds, sulfonium compounds, sulfamide compounds, iodonium compounds, sulfonyl diazomethane compounds and mixtures thereof.

The mixing ratio of the photo-acid generating agent in the liquid composition may be confined within the range of 0.5 to 10 parts by weight in bulk per 100 parts by weight of the acid-polymerizable solvent. If the photo-acid generating agent is employed together with polycarbonate as a 1:1 mixture, the photo-acid generating agent can be employed at a ratio of about 1 to 20 parts by weight per 100 parts by weight of the acid-polymerizable solvent. A more preferable mixing ratio of the photo-acid generating agent in the liquid composition would be 1 to 12 parts by weight per 100 parts by weight of the acid-polymerizable solvent.

When a coloring component is incorporated in the liquid composition in addition to the aforementioned components, the liquid composition can be formulated into an electromagnetic radiation-curing type UV ink. As for the coloring component, it is possible to employ pigments which can be organic or inorganic. The mixing ratio of the coloring component in the liquid composition may be confined within the range of 0 to 20 parts by weight per 100 parts by weight of the acid-polymerizable compound. A more preferable mixing ratio of the coloring component in the liquid composition would be about 3 to 6 parts by weight per 100 parts by weight of the acid-polymerizable compound.

The electromagnetic radiation-curing type liquid composition to be employed in the method according to one embodiment of the present invention can be manufactured by a process wherein predetermined components are homogenously mixed together and then filtered using a PTFE filter for example to obtain the liquid composition.

Next, the inkjet recording apparatus according to one embodiment of the present invention will be explained with reference to the drawings.

FIG. 1 shows schematically the inkjet recording apparatus according to one embodiment of the present invention. This inkjet recording apparatus 1 is provided with transferring means 3. Along the moving direction of this transferring means 3, there are successively arrayed, from the upstream side to the downstream side, a recording medium temperature-controlling means 7, an inkjet type recording head 4, a light-irradiating means 5, and a heating means 6.

With respect to the recording medium 2, there is no any particular limitation on the kinds thereof as long as printing is enabled to be performed thereon. Namely, it is possible to employ, for example, various kinds of materials including paper, an OHP sheet, a resin film, non-woven fabric, a porous film, a plastic plate, a circuit board and a metallic substrate.

The transferring means 3 is constructed so as to enable the recording medium 2 to pass successively through the recording medium temperature-controlling means 7, the recording head 4, the light-irradiating means 5 and the front surface of heating means 6. In this case, the transferring means 3 is designed such that the recording medium 2 can be transferred from the right side to the left side in the drawing. This transferring means 3 can be constituted for example by a belt and/or a roller for transferring the recording medium 2, and a driving mechanism (not shown) for driving the belt and/or the roller. Further, this transferring means 3 may be further provided with a guiding member for assisting the transfer of the recording medium 2. Alternatively, this transferring means 3 may be formed of a stage structure which is designed to run slidably on a linear base so as to transfer the recording medium 2 of sheet-like configuration.

The recording head 4 delivers an electromagnetic radiation curing type UV ink onto the recording medium 2 according to image signals, thereby forming an ink layer. As already explained above, the electromagnetic radiation curing type UV ink is an electromagnetic radiation curing type liquid composition. As for the recording head 4, it is possible to employ, for example, a serial scanning type head mounted on a carriage or a line scanning type head having a width which is the same as or larger than the width of the recording medium 2. As far as high-speed printing is concerned, the latter is generally more advantageous as compared with the former. As for the manner of delivering the electromagnetic radiation curing type UV ink from the recording head 4, there is no any particular limitation. For example, it is possible to employ a method where ink droplet will be ejected taking advantage of the pressure of vapor that can be generated by the heat of a heating element. Alternatively, the ink droplet may be ejected by taking advantage of a mechanical pressure pulse that can be generated by a piezoelectric element.

The light-irradiating means 5 as an irradiation source irradiates light to the ink layer formed on the recording medium 2, thus generating acid in the ink layer. As for the light-irradiating means 5, it is possible to employ, for example, a mercury lamp such as a low, medium or high pressure mercury lamp; a tungsten lamp; a xenon lamp; an arc lamp; an excimer lamp; an excimer laser; a semiconductor laser; a YAG laser; a laser system constituted by a combination of laser and non-linear optical crystal; a high-frequency induction ultraviolet generating apparatus; an electron beam irradiating apparatus; an X-ray irradiating apparatus; etc. Among them, the employment of the high-frequency induction ultraviolet generating apparatus, the high/low pressure mercury lamp and the semiconductor laser would be more preferable, since these devices are advantageous in simplifying the system involved. When ultraviolet rays are to be employed, the wavelength of the ultraviolet rays should preferably be confined within the range of 100 nm to 600 nm. The light to be irradiated from the light-irradiating means 5 may not be restricted to ultraviolet rays. Namely, the light can be optionally selected depending on the photosensitive wavelength of the photo-acid generating agent included in the electromagnetic radiation-curing type liquid composition or in the electromagnetic radiation-curing type UV ink. It is especially preferable to employ the light having a peak illuminance in the vicinity of 250 nm or 365 nm. The light-irradiating means 5 may be provided with a converging mirror or a sweep optical system.

The heating means (heat source) 6 is employed to heat the ink layer on the recording layer 2 so as to promote the cross-linking reaction using, as a catalyst, the acid that has been generated in the ink layer by the irradiation of electromagnetic radiation. As for the heating means 6, it is possible to employ an infrared lamp, a halogen heater, a far-infrared ceramic heater, a roller provided therein with a heating element (heat roller), a blower for blowing out hot air or heated air, etc. If a metallic recording medium is to be employed in a high-speed printing apparatus where the printing speed thereof is as high as several tens of meters per minute in particular, it is desirable that the surface temperature of the recording medium can be instantaneously risen. This can be realized by using a non-contact type converging halogen heater. Alternatively, the non-contact lamp type heating means 6 may be provided with a converging mirror.

On this occasion, the quantity of heat to be applied to the recording medium 2 for heating the UV ink layer formed on the recording medium 2 can be determined as follows irrespective of the kinds, quality and thickness of the recording medium, thereby making it possible to further enhance the curing efficiency. Namely, it is desired that the peak temperature of the surface of recording medium 2 is increased by at least about 90° C. higher than the initial temperature (the initial temperature of the recording medium that has been preliminarily heated by the recording medium temperature-controlling means 7).

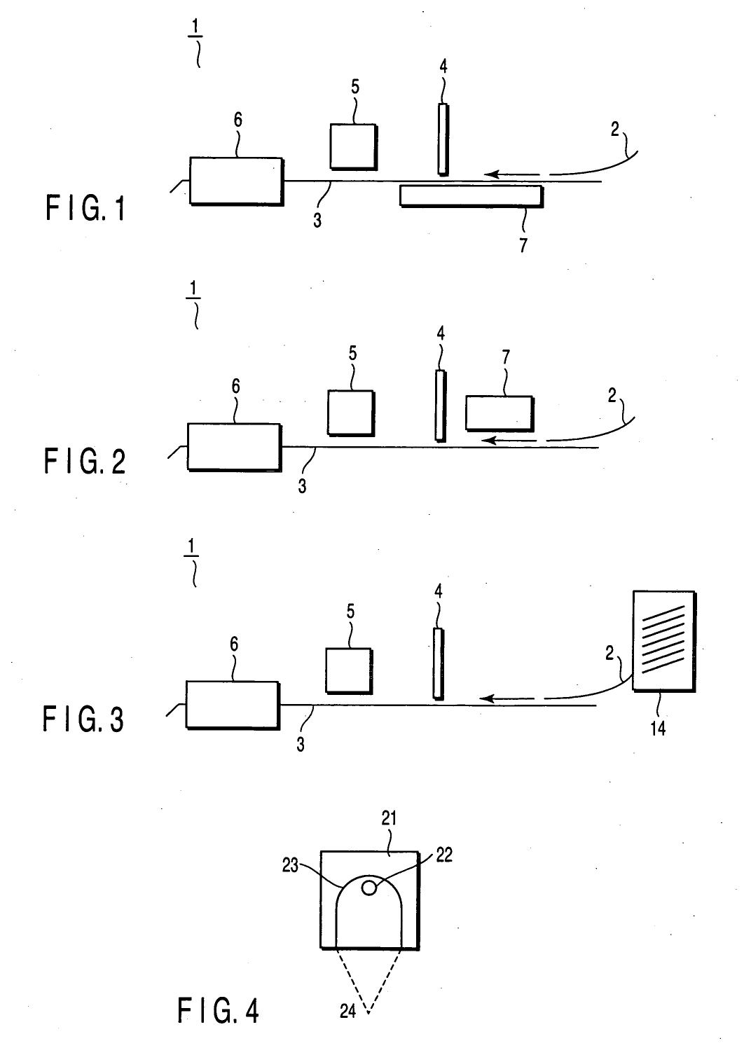

The recording medium temperature-controlling means 7 may be disposed on any side of the transferring means 3, i.e. below or over the transferring means 3, and may be of stationary type or mobile type. Further, the recording medium temperature-controlling means 7 may be of contact type or non-contact type. One example of the non-contact type inkjet recording apparatus is schematically shown in FIG. 2. In the inkjet recording apparatus shown in FIG. 2, the non-contact type recording medium temperature-controlling means 7 is disposed over the transferring means 3.

If the recording medium 2 is to be preliminarily heated, the recording medium temperature-controlling means 7 may not necessarily be installed in the inkjet recording apparatus 1. For example, as shown in FIG. 3, a recording medium preliminary heating stocker 14 can be disposed at a fore-stage of the transferring means 3 of the inkjet recording apparatus 1. The recording medium 2 placed inside the recording medium preliminary heating stocker 14 is collectively and preliminarily heated up to a predetermined temperature by the heating means (not shown) mounted in the recording medium preliminary heating stocker 14 and then transferred by the transferring means 3. This method is effective in the case where the recording medium has a large heat capacity and the surface temperature cannot be instantaneously lowered. In particular, this method is especially effective in the case where the recording is performed on the recording medium 2 made of a metal of high density or high specific gravity or made of a bulky material which is large in thickness for example.

In either cases, by using the recording medium temperature-controlling means 7, the recording medium 2 to be transferred by the transferring means 3 is preliminarily heated and then further heated up to a predetermined temperature until the recording medium 2 reaches the recording head 4. Further, due to the preliminary heating of the recording medium 2, it is possible to obtain the effect of promoting the heating by the heating means 6 to the ink layer formed on the recording medium 2.

As for the recording medium temperature-controlling means 7, it is possible to employ an infrared lamp, a halogen heater, a far-infrared ceramic heater, a roller provided therein with a heating element (heat roller), an IH heater, a blower for blowing out hot air or heated air, etc. When the recording medium 2 is made of metal and a non-contact type heating means as shown in FIG. 2 is to be employed, it is preferable to employ a far-infrared ceramic heater. Further, if it is required to employ a high-speed printing apparatus where the printing speed thereof is as high as several tens of meters per minute or if the surface temperature of recording medium is required to be instantaneously increased up to a high temperature, the recording medium temperature-controlling means 7 in the non-contact type heating means shown in FIG. 2 should be constructed such that it can be instantaneously heated up. More specifically, the employment of a converging halogen heater is more effective in this case. FIG. 4 shows a cross-sectional view of one example of halogen heater which is useful in this case. As shown in FIG. 4, the halogen heater 22 is encircled by a reflection plate 23 and placed inside the housing 21. A focal point 24 is located at a predetermined point below the halogen heater 22, thereby enabling the light to converge at this point. Therefore, it is desired to set the halogen heater at a suitable location so as to enable the recording medium 2 to pass through this focal point 24.

Next, the method of performing printing (the formation of images) on the recording medium 2 by using the inkjet recording apparatus 1 shown in FIG. 1 will be explained in detail.

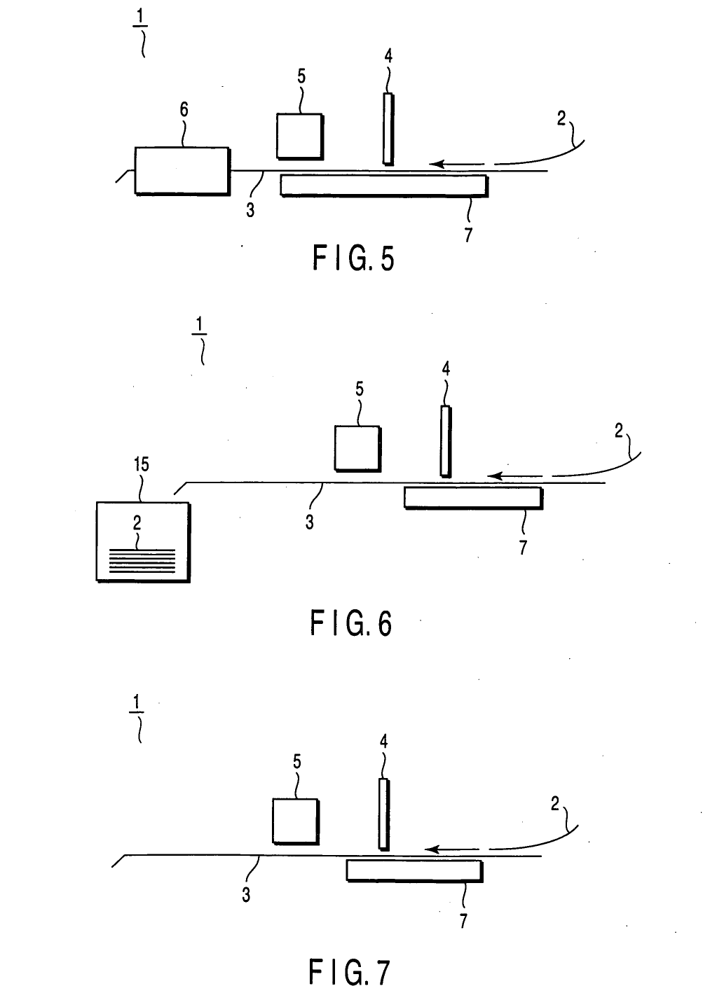

First of all, by using the transferring means 3, the recording medium 2 is transferred from the right side to the left side in the drawing. The speed of transferring the recording medium 2 can be suitably selected depending on the object of use. For example, the transferring speed can be controlled in the order of several tens meters per minute. As the recording medium 2 is being transferred, the recording medium 2 is preliminarily heated by the recording medium temperature-controlling means 7 disposed below the transferring means 3. The region in which the recording medium 2 is preliminarily heated by the recording medium temperature-controlling means 7 may be limited to the vicinity of the location where printing images are to be formed by the recording head 4 as shown in FIG. 1. Alternatively, the region in which the recording medium 2 is preliminarily heated may be limited to the vicinity of the location just before the heating means 6 where the recording medium 2 can be irradiated with electromagnetic radiation such as ultraviolet rays (the irradiation of light) by the light-irradiating means 5 as shown in FIG. 5.

A specific region for performing the preliminary heating can be suitably set by taking various factors into consideration such as the curing sensitivity of the electromagnetic radiation-curing type liquid composition or the UV ink, the transferring speed of the printing surface (the transferring speed of the recording medium 2), the kinds (the quality of material, thickness, etc.) of the recording medium 2, etc. However, it is required that the temperature of the recording medium 2 at the moment when the recording medium 2 has reached the recording head 4 is higher than the temperature of the ink being delivered from the recording head 4. The temperature of the ink to be delivered generally confined to the range of about 20 to 60° C., so that if the temperature of the recording medium 2 is the same with or lower than this range of temperature, it would be impossible to effectively cure the ink layer. Therefore, the optimal conditions for the irradiation of electromagnetic radiation (the irradiation of light) which are required for the curing of ink would be confined to a narrow range.

The temperature for the preliminary heating of the recording medium 2 to be transferred may be such that would not interfere with the effects to be derived from the heating by the heating means 6 as described hereinafter. Further, this temperature should preferably be as high as possible as long as it does not cause the deformation of the recording medium 2. It is also required that the heat emitted from the light-irradiating means can be effectively applied to the ink without being taken away, for example, by the transferring means of recording medium. It is preferable that the acid which is required for curing is sufficiently diffused into a deep portion of the ink layer and the recording medium 2 is preliminarily heated up to a temperature which makes it possible to perform uniform curing of ink prior to the irradiation of electromagnetic radiation (the irradiation of light). Therefore, the preliminarily heating of the recording medium 2 is performed to such an extent that the heating thereof is no longer required after the irradiation of light and that the uniform curing of the ink layer through the diffusion of the acid required for curing into a deep portion of ink layer can be effectively exhibited. Actually, it is desirable to perform a preliminary experiment for the assessment of the curing characteristics of ink, thereby determining the conditions for the preliminary heating of the recording layer. More specifically, the preliminary heating can be performed at a temperature ranging from 35 to 120° C., more preferably from 50 to 70° C. though it depends on the composition of ink, the temperature of ink, the quality of material of the recording medium, etc.

At the moment when the recording medium 2 is transferred to the front of recording head 4, an electromagnetic radiation-curing type UV ink is delivered from the recording head 4 in conformity with the signals of images. As a result, an ink layer can be formed on the recording medium 2.

The recording medium 2 having the ink layer formed thereon is transferred to the front of the light-irradiating means 5. As the recording medium 2 is being permitted to pass through the front of the light-irradiating means 5, light is irradiated onto the ink layer from the light-irradiating means 5 to generate an acid in the ink layer. The intensity of the radiation at the location of the surface of ink layer may be generally confined within the range of several mW/cm² to 10 W/cm², though it differs depending on the wavelength of light source to be employed. Preferably, the intensity of the radiation may be confined within the range of several tens of mW/cm² to 5 W/cm² or so. The quantity of exposure to be applied to the ink layer can be optionally set in conformity with the sensitivity of ink as well as with the moving speed of printing surface (the transferring speed of the recording medium 2).

Then, the recording medium 2 is transferred into or in the vicinity of the heating means 6. As the recording medium 2 passes through the interior of the heating means 6 or passes in the vicinity of the heating means 6, the ink layer formed on the recording medium 2 is heated by the heating means 6 to promote the cross-linking reaction in the ink layer. Incidentally, in the case of the inkjet recording apparatus shown in FIG. 1, the heating time by the heating means 6 is generally relatively short, i.e., ranging from less than one second to several tens of seconds. Therefore, if it is desired to enable the ink layer to be substantially completely cured by the heating means 6, the heating should preferably be performed in such a manner that the maximum ultimate temperature becomes relatively high, for example about 200° C. or less, especially about 80 to 200° C. Alternatively, the heating may be performed with the maximum ultimate temperature being confined within the range of about 60 to 180° C.

The heating by the heating means 6 may be omitted through the optimization of the composition of ink, or the optimization of the aforementioned preliminary heating and of the irradiating conditions of electro-magnetic radiation. Thereafter, the recording medium 2 is transferred into the stocker (or a container) (not shown), thereby accomplishing the printing.

The heating means for heating the ink layer is not necessarily limited to the heating means 6 which is disposed on the downstream side of the light-irradiating means 5 as shown in FIG. 1. For example, it is possible to employ a stocker 15 provided with the heating means as shown in FIG. 6. A plurality of recording mediums 2 that have been subjected to exposure process can be accommodated in this stocker 15 provided with the heating means to perform the heating en bloc of these recording mediums 2. Alternatively, the light-irradiating means 5 may be moved close to the recording medium 2 to such an extent that would not cause any damage to the printing surface on the occasion of performing the exposure of the ink layer, thereby utilizing the light-irradiating means 5 as a heating source. It is also possible to utilize the light source as a heating source by not attaching any heat-removing mechanism such as a cold mirror to the light source. If a high-output bulb of several hundreds watts is to be employed, since the bulb is provided with a cooling mechanism in advance, it is possible to partially modify this cooling mechanism so as to make up a mechanism which makes it possible to intentionally utilize the heat of the bulb for the heating of the recording medium 2. By doing so, the ink layer can be heated by using the heat generated from the light-irradiating means 5.

More specifically, it is possible to employ the light-irradiating means 5 having an output of not less than one hundred watts and provided with a mechanism which is designed such that an air stream employed for cooling the light-irradiating means 5 is enabled to re-introduce into the recording medium 2 or into the transferring/holding mechanism, thereby making it possible to utilize the air stream for the heating of the ink layer. The ultimate temperature of the recording medium 2, which can be derived from the utilization of the heat from the light-irradiating means 5, may be such that makes it possible to obtain the same degree of effects as obtainable from the heating by the aforementioned heating means 6. Although a preferable range of temperature may differ depending on the period of heating time, the temperature should be at least 60° C. or more in general, more preferably 80-100° C. Further, when the velocity of exposure is as high as several meters per second, the temperature may be as high as 180° C. or so, since the ink layer is required to be instantaneously heated.

When, for example, a light-irradiating means which is capable of emitting infrared ray in addition to the visible light is employed as the light-irradiating means 5, it is possible to perform the heating concurrently with the irradiation of light. In this case, the curing of the ink layer can be preferably promoted.

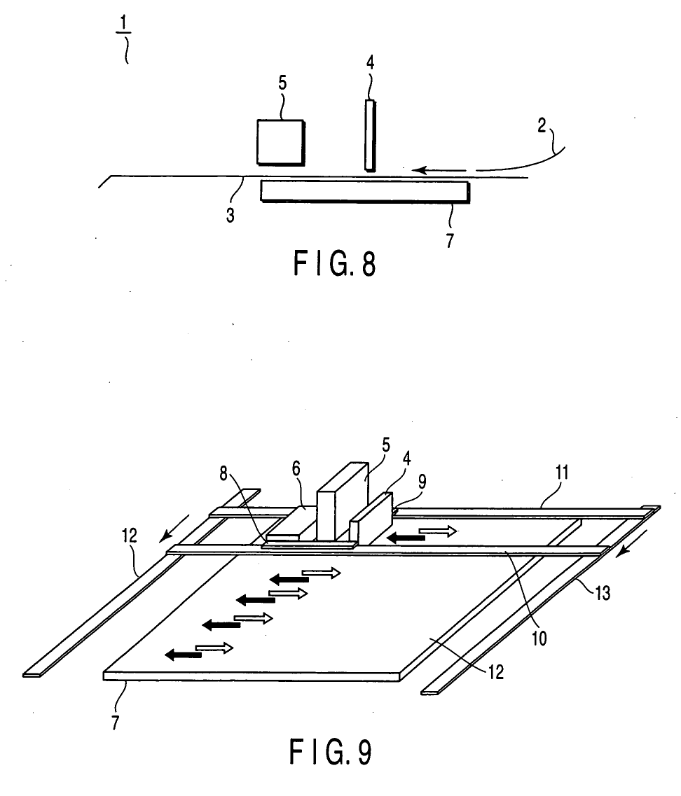

Incidentally, if the electromagnetic radiation-curing type UV ink to be delivered from the recording head 4 contains a very small quantity of coloring component, it can be deemed as being an electromagnetic radiation-curing type liquid composition excellent in transparency. Therefore, the electromagnetic radiation such as ultraviolet rays to be irradiated from the light-irradiating means 5 (irradiated light) would be enabled to easily reach a deep portion of the liquid composition. As a result, it is possible to reduce the irradiating output of the light-irradiating means 5. Further, it is possible to lower the temperature (output: quantity of heat required) of the heating means 6, thus leading to the miniaturization of heating means 6. Furthermore, depending on the conditions, the layer of the liquid composition can be sufficiently cured by the radiant heat to be emitted, concurrently with the light, from the light-irradiating means 5 in addition to the preliminary heating thereof by the recording medium temperature-controlling means 7. In this case, the heating of the layer of the liquid composition may not necessarily be performed after the irradiation of light and hence the heating means 6 as shown in FIG. 7 or FIG. 8 can be omitted. As a result, the inkjet recording apparatus 1 can be miniaturized.

If an electromagnetic radiation-curing type UV ink containing a coloring component is employed, the electromagnetic radiation to be irradiated from the light-irradiating means 5 can hardly penetrate into a deep portion of the liquid composition as compared with the aforementioned electromagnetic radiation-curing type liquid composition which is excellent in transparency. In the case where the layer of the liquid composition to be formed is relatively large in thickness, it would become more difficult to enable the light to reach a deep portion of the liquid composition, so that it would be required to study the quantity of the photo-acid generating agent to be included in the UV ink. In the case of the recording apparatus according to one embodiment of the present invention, the recording medium 2 is preliminarily heated by the recording medium temperature-controlling means 7, thereby allowing the acid required for the curing the ink layer to be sufficiently diffused into a deep portion of the ink layer. As a result, it is possible to lower the temperature (output: quantity of heat required) of the heating means 6, thus leading to the miniaturization of heating means 6. Furthermore, depending on the conditions, the layer of the electromagnetic radiation-curing type UV ink can be sufficiently cured by only the radiant heat to be emitted, concurrently with the light, from the light-irradiating means 5 in addition to the preliminary heating thereof by the recording medium temperature-controlling means 7. In this case, the heating of the layer of the UV ink may not necessarily be performed after the irradiation of light and hence the heating means 6 as shown in FIG. 7 or FIG. 8 can be omitted as in the case of the electromagnetic radiation-curing type liquid composition excellent in transparency. In this case, as explained with reference to FIG. 7 or FIG. 8, the inkjet recording apparatus 1 can be miniaturized.

The inkjet recording apparatus 1 according to one embodiment of the present invention may be a flat bed type inkjet recording apparatus. One example thereof is schematically illustrated in FIG. 9. In the inkjet recording apparatus shown in FIG. 9, while the recording medium 2 is fixed, the inkjet recording head 4 and the light-irradiating means 5 are enabled to move to form an image. Below a recording medium-fixing stage, there is disposed the recording medium temperature-controlling means 7, by which the recording medium 2 is entirely subjected to preliminary heating to perform the formation of image.

This inkjet recording apparatus 1 comprises the inkjet recording head 4, the light-irradiating means 5, and the heating means 6, thereby constituting an inkjet recording unit. In the execution of printing, the recording head 4 is serially and reciprocatively moved over the recording medium 2 which is fixed to the recording medium-fixing stage.

This inkjet recording unit is fixed as one unit by a couple of guides 8 and 9 positioned on the opposite sides of the inkjet recording unit and is constructed such that it is placed on a couple of front and rear rails 10 and 11 which are disposed parallel to each other and that it is enabled to move reciprocatively in the directions indicated by the white arrow and the black arrow shown in the drawing. As for the method of moving the inkjet recording unit, it is possible to employ a wire which is attached, in a stretched state, to a stepping motor, etc. so as to enable the inkjet recording unit to be pulled by the wire. Alternatively, it is also possible to construct the inkjet recording unit just like a linear slider so as to enable the inkjet recording unit to move by itself.

The front and rear rails 10 and 11 are fixed in parallel and designed to be moved in the direction of the arrow along a couple of left and right rails 12 and 13 disposed parallel to each other, both being positioned respectively on the outer sides of the recording medium 2.

On the occasion of performing inkjet recording by using the inkjet recording apparatus which is constructed as described above, the inkjet recording unit is transferred in the direction of the white arrow as shown in the drawing, in the course of which images are formed on the recording medium 2. After finishing the formation of the images during this one-way transferring of the inkjet recording unit, the inkjet recording unit is moved in the direction of the black arrow along the left and right rails 12 and 13 disposed parallel to each other, thereby shifting the inkjet recording unit to an unrecorded portion of the recording medium 2 in the course of the backward movement of the inkjet recording unit in the direction indicated by the black arrow. Then, in the same manner as described above, the inkjet recording unit is transferred in the direction of the white arrow, in the course of which images are formed on the recording medium 2. These operations are repeated, thereby making it possible to form images on a large recording medium 2.

Even in the case of the aforementioned flat bed type inkjet recording apparatus, the recording medium 2 is preliminarily heated by the recording medium temperature-controlling means 7 in the same manner as in the case of the aforementioned inkjet recording apparatus, thereby making it possible to expect the effects of miniaturizing the heating means 6.

Next, the embodiment of the present invention will be explained in detail with reference to specific examples.

An electromagnetic radiation-curing type liquid composition and an electromagnetic radiation-curing type UV ink were prepared to investigate the curing properties thereof. In the preparation of these compositions, two kinds of epoxy compounds Ep1 and Ep2 both represented by the following chemical formulas were mixed together at a mixing ratio of 7:1 (weight ratio) to obtain an acid-polymerizable composition (epoxy composition) “a”.

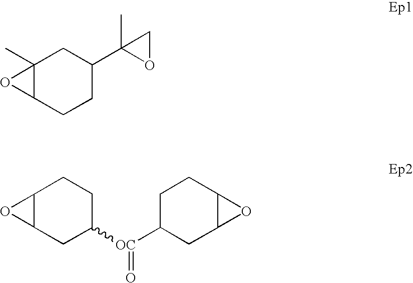

Ep1: 1,2:8,9 diepoxylimonene;

Ep2: ε-caprolactone-modified 3,4-epoxycyclohexylmethyl 3′,4′-epoxycyclohexane carboxylate.

Carbon black pigment employed as a coloring component (5% by weight) was mixed with acrylic resin and kneaded. This kneaded mixture and 200 ppm of nonionic surfactant (Sumitomo 3M Co., Ltd.) were added to the aforementioned epoxy composition “a”. Thereafter, the resultant mixture was subjected to dispersion treatment a whole day and night by a paint shaker to obtain a black color composition “a(B)”.

This black color composition “a(B)” was then mixed with a photo-acid generating agent at the ratios shown in the following Table 1 and stirred. The resultant mixture was then subjected to filtration using a 5 μm PTFE filter to prepare sample compositions (1) and (2). The sample composition (1) was an electromagnetic radiation-curing type liquid composition, while the sample composition (2) was an electromagnetic radiation-curing type UV ink (hereinafter referred to as UV ink).

TABLE 1

| Composition | Black | Photo-acid generating |
|---|---|---|
| No. | composition | agent (wt %) |
| 1 | None | PAG3(8%) |
| 2 | a(B) | PAG3(8%) |

The PAG3 employed herein as a photo-acid generating agent was a propylene carbonate solution comprising, at a concentration of 50% by weight, a 1:1 mixture of the compounds PAG1 and PAG2 represented by the following chemical formulas. Further, this PAG3 was available in the market, the trademark thereof being UVACURE 1591 (Daicel UCB Co., Ltd.).

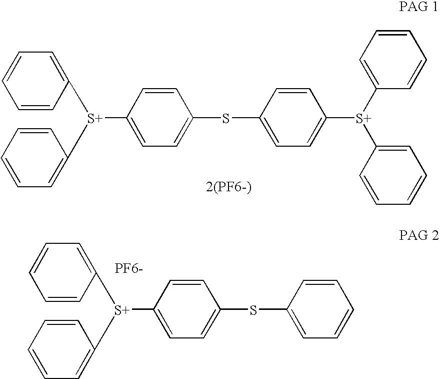

By using the inkjet recording apparatus 1 shown in FIG. 1, the printing was performed by using the sample compositions (1) and (2) and the curing properties thereof were investigated. The components of the inkjet recording apparatus 1 were respectively prepared as follows. As for the transferring means 3, a metallic endless belt excellent in heat resistance and low in heat capacity was employed and disposed in a tensioned manner between a driving roller and a follower roller. As for the recording head 4, an inkjet recording head CB1 (trademark; Toshiba TEC Co., Ltd.) was employed. As for the light-irradiating means 5, a UV irradiation system HP-6 (D bulb: peak wavelength=350-390 nm; Fusion UV Systems Japan Co., Ltd.) was employed. As for the heating means 6, a far-infrared ceramic heater PLC-33 series (Noritake Co., Ltd.) was employed. The recording medium temperature-controlling means 7 was constituted by a structure comprising a silicone rubber heater (OM Heater Co., Ltd.) which was stuck to a heat-resistive resin plate of low heat conductivity such as a POM plate, the recording medium temperature-controlling means 7 being disposed immediately below the transferring means 3 and along a region extending from the medium-feeding point to the location of the light-irradiating means 5.

All of the samples were printed under the following conditions.

Resolving power of recording head 4: 600 dpi;

Volume of delivered ink: 42 pL/each nozzle;

Printing speed (moving velocity of the belt employed as a recording medium transferring means): 25 m/min.;

Output of irradiation (large): 2600 mW/cm²;

Output of irradiation (small): 1800 mW/cm²;

Heating temperature (surface temp. of recording medium): 100° C. (passing time: about 5 sec.) Preliminary heating temperature: 60° C.

The output of irradiation denotes the illuminance of ultraviolet rays, which was measured by using an ultraviolet ray dosimeter (an industrial UV checker of Topcon Corporation; UVR-T1). This illuminance was adjusted by using an output adjusting thumbscrew (volume) of a UV irradiation system HP6 (Fusion UV Systems Japan Co., Ltd.).

Under the conditions described above, each of the compositions was printed on a PET sheet (200 μm in thickness) employed as a recording medium and the hardness of the printed images after the curing thereof was also measured by pencil hardness testing method. The measurement of the curability (hardness) of the printed images was performed according to JIS K5600-5-4 (Mitsu-Bishi pencils 2B-2H were employed) and the hardness was judged based on the following four levels, i.e. A, B, C and D. The results obtained on the sample compositions (1) and (2) are respectively summarized in the following Tables 2 and 3.

A: H or more

B: F

C: B and HB

D: 2B

TABLE 2

| | |
|---|---|
| Irradiation | Irradiation |
| output | Output |
| (large) | (small) |
| Heating | Heating |

| | | Yes | No | Yes | No |
|---|---|---|---|---|---|
| Preliminary | No | A | B | B | C |
| heating | Yes | A | A | A | B |

TABLE 3

| | |
|---|---|
| Irradiation | Irradiation |
| output | Output |
| (large) | (small) |
| Heating | Heating |

| | | Yes | No | Yes | No |
|---|---|---|---|---|---|
| Preliminary | No | B | D | C | D |
| heating | Yes | A | B | B | C |

As shown in Table 2, in the case of the electromagnetic radiation-curing type liquid composition, it was possible, through the preliminary heating of the liquid composition formed on the surface of recording medium, to effectively apply the heat emitted from the light-irradiating means to the ink while making it possible to prevent the heat from being taken away by the transferring means of the recording medium, etc. As a result, it was possible to enable the acid required for the curing of ink to sufficiently diffuse into a deep portion of the ink layer and to perform uniform curing of the ink layer, thus not necessitating the heating of the ink layer after the irradiation thereof.

In the case of the UV ink also, it was possible, through the preliminary heating of the UV ink, to effectively apply the heat from the heating means to the UV ink layer while making it possible to prevent the heat from being taken away by the transferring means of the recording medium, etc., as shown in Table 3. In this manner, it was possible to enable the acid required for the curing of ink to sufficiently diffuse into a deep portion of the ink layer and to perform uniform curing of the ink layer. As a result, it was possible to simplify or miniaturize the heating means to be employed subsequent to the irradiation of light or to decrease the output of the heating means. Under certain circumstances, the heating means to be employed subsequent to the irradiation of light may be omitted.

As described above, since the recording medium is preliminarily heated, thereby heating the layer of electromagnetic radiation-curing type liquid composition, it is possible to utilize, to a maximum degree, the energy (ordinary, light and heat) to be emitted from the light-irradiating means for irradiating electromagnetic radiation as well as the heat to be derived from the heating means. Namely, the inkjet recording apparatus is only required to be provided with a small-scale preliminary heating means, thereby not necessitating the provision of a large-scale heating means, thus leading to the miniaturization of the apparatus. Further, the preliminary heating is effective in lowering the viscosity of the ink adhered onto the recording medium, thus enhancing the wettability of the ink to the recording medium, thereby enhancing the adhesion between the ink layer and the recording medium.

Further, a UV ink was prepared to investigate the curing properties thereof under various conditions.

In the preparation of the UV ink, the aforementioned epoxy compound Ep1 (1,2:8,9 diepoxylimonene) and an epoxy compound Ep3 represented by the following chemical formula (neopentylglycol diglycidyl ether) were mixed together at a mixing ratio of 1:1 (weight ratio) to obtain an acid-polymerizable composition (epoxy composition) “b”. Incidentally, the epoxy compound Ep1 was formed of Celloxide 3000 (Daicel Chemicals Co., Ltd.) and the epoxy compound Ep3 was formed of SR-NPG (Sakamoto Yakuhin Co., Ltd.).

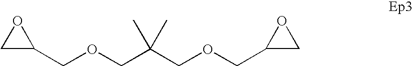

Carbon black pigment employed as a coloring component (4% by weight) was mixed with acrylic resin and kneaded. This kneaded mixture and 200 ppm of nonionic surfactant (Sumitomo 3M Co., Ltd.) were added to the aforementioned epoxy composition “b”. Thereafter, the resultant mixture was subjected to dispersion treatment a whole day and night by a paint shaker to obtain a black color composition “b(B)”.

This black color composition “a(B)” was then mixed with a photo-acid generating agent at the ratios shown in the following Table 4 and stirred. The resultant mixture was then subjected to filtration using a 5 μm PTFE filter to prepare sample composition (3). The sample composition (3) was a UV ink.

TABLE 4

| | | Photo-acid |
|---|---|---|
| Composition | Black | generating |
| No. | composition | agent (wt %) |
| 3 | b(B) | PAG6(10%) |

The PAG6 employed herein as a photo-acid generating agent was a propylene carbonate solution comprising, at a concentration of 50% by weight, a 1:1 mixture of the compounds PAG4 and PAG5 represented by the following chemical formulas. Further, this PAG6 was available on the market, the trademark thereof being ESACURE 1064 (Lamberty Co., Ltd.).

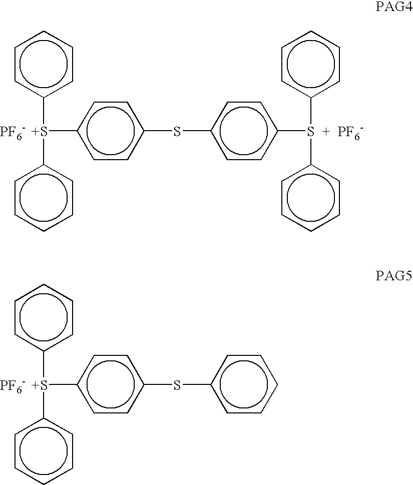

By using the inkjet recording apparatus 1 shown in FIG. 1, the printing was performed by using the sample composition (3) and the curing properties thereof were investigated. The components of the inkjet recording apparatus 1 were respectively prepared as follows. As for the transferring means 3, a metallic endless belt excellent in heat resistance and low in heat capacity was employed and disposed in a tensioned manner between a driving roller and a follower roller. This transferring means 3 was constructed such that the recording medium 2 could be secured to a surface portion of the driving roller only when the printing was performed on the recording medium 2. As for the recording head 4, an inkjet recording head CB1 (trademark; Toshiba TEC Co., Ltd.) was employed. As for the light-irradiating means 5, a converging type UV irradiation system LP-6 (D bulb: peak wavelength=350-390 nm, standard reflection mirror; Fusion UV Systems Japan Co., Ltd.) was employed and positioned at a location which was spaced away from the recording head 4 by a distance of about 417 mm in the transferring direction.

As for the heating means 6, a halogen heater unit NIL series (gold-plated converging mirror surface; Infridge Industries Co., Ltd.) was employed. A single or a plurality of heating means 6 were disposed at a location which was spaced away from the light-irradiating means 5 by a distance of about 417 mm in the transferring direction. The heating means employed herein was a halogen heater as shown in cross-section in FIG. 4 and was disposed so as to enable the light to converge at the focal point 24 which was located 25 mm below this heating means. The recording medium temperature-controlling means 7 was constituted by a structure comprising a silicone rubber heater (OM Heater Co., Ltd.) which was stuck to a heat-resistive resin plate of low heat conductivity such as a POM plate, the recording medium temperature-controlling means 7 being disposed immediately below the transferring means 3 and along a region extending from the medium-feeding point to the location of the light-irradiating means 5, thereby making it possible to preliminarily heat the recording medium 2.

As for the recording medium temperature-controlling means 7, it may not necessarily be constructed as described above, but may be of non-contact type utilizing radiant heat or of a hot air-blowing type. Such a non-contact type recording medium temperature-controlling means may be formed of a halogen heater unit NIL series (gold-plated converging mirror surface; Infridge Industries Co., Ltd.) employing the heating means 6. If the recording medium 2 is formed of a metal such as iron, a self-exothermal heater utilizing, for example, electromagnetic induction heating may be employed as a recording medium temperature-controlling means.

The printing conditions (conditions for forming a cured ink film) in this example were as follows.

Resolving power of recording head 4: 600 dpi;

Volume of delivered ink: 42 pL/each nozzle;

Ink delivery temperature from recording head 4: about 40° C.;

Printing speed (transferring velocity of the recording medium by recording medium-transferring means 3): 25 m/min.

As for the light-irradiating means 5, ultraviolet ray having a peak at a wavelength of around 365 nm was employed and the output thereof was suitably altered within the following ranges.

Illuminance of irradiation: 263-2429 mW/cm²;

Integrated quantity of light: 4-236 mJ/cm².

The heating conditions by the heating means 6 were set in such a manner that the heater output per 1 cm in the longitudinal direction of halogen lamp was suitably changed within the range of 0.117-0.936 KW/cm.

By using the inkjet recording apparatus 1 constructed as described above and the sample composition (3), a cured solid image was formed on a stainless metal plate (100 μm in thickness). In this printing, the recording medium 2 was transferred at a velocity of 25 m/min and conditions such as the illuminance of irradiation and the quantity of light in the operation of the light-irradiating means 5 and the heater output of the heating means 6 were variously changed.

The irradiation output (illuminance of ultraviolet rays/integrated quantity of light) of the light-irradiating means 5 was a value which was measured by using an ultraviolet ray dosimeter (an industrial UV checker of Topcon Corporation; UVR-T1, light-detecting portion: UD-T36; peak sensitive wavelength: about 350 nm). Further, the output of the irradiation of light was adjusted within the range of 25-100% by using an output adjusting thumbscrew of the aforementioned UV irradiation system.

The curing property of the cured material on the recording medium 2 was investigated respectively on the case where the preliminary heating of the recording medium 2 by the recording medium temperature-controlling means 7 of the inkjet recording apparatus was not performed (temperature of the recording medium 2: about 30° C.) and on the case where the aforementioned preliminary heating of the recording medium 2 was performed (temperature of the recording medium 2: about 50° C.). For the assessment of the curing property, the tack-free property and pencil hardness were measured.

Tack-free property herein means the probabilities of the retro-transcription of ink onto the rear surface of the recording medium 2 that has been superimposed on another recording medium 2 when a plurality of recording mediums 2 each bearing printed images thereon are piled on one another. Thus, tack-free means the case wherein even if a plurality of recording mediums 2 each bearing printed images thereon were piled on one another, there is no possibility that the ink formed on the surface of one of the recording mediums 2 can be transcribed onto the rear surface of overlying recording medium 2. More specifically, the tack-free property of cured ink film can be determined by subjecting the cured ink film formed on the recording medium 2 to rubbing several times by using a paper wiper (Chymwipe; Cresia Co., Ltd.). The tack-free property of cured ink film was assessed based on the following criteria.

◯: Tack-free (even if the cured ink film was rubbed five times with the employment of Chymwipe, the ink was not scraped off)

Δ: Somewhat tack-free (when the cured ink film was rubbed five times with the employment of Chymwipe, the adhesion of the ink to the Chymwipe was admitted)

X: Not tack-free (when the cured ink film was rubbed once with the employment of Chymwipe, the adhesion of the ink to the Chymwipe was admitted; i.e. not sufficiently cured)

Namely, if the ink layer is tack-free, it can be determined that the UV ink layer on the recording medium 2 has been substantially completely cured.

The measurement of the pencil hardness of the printed image was performed according to JIS K5600-5-4 (Mitsu-Bishi pencils 2B-2H were employed). In the combination of the UV ink employed in this example with the recording medium 2 (stainless metal plate), the pencil hardness of the printed image is required to be “H” or more.

Table 5 shows the results of samples on which the preliminary heating was not performed and Table 6 shows the results of samples on which the preliminary heating was performed. The upper line of each column denotes the tack-free property of the cured ink film, and the lower line of each column denotes the pencil hardness of the cured ink film. When the tack-free property was “O” and the pencil hardness was “H” or more in the determination of curing conditions, it can be said as being an appropriate range of curing conditions.

TABLE 5

| | Quantity | | | | | | | | | | |
|---|---|---|---|---|---|---|---|---|---|---|---|
| Illuminance | of light | Output of heater (kW/cm) | | | | | | | | | |
| (mW/cm²) | (mJ/cm²) | 0.117 | 0.146 | 0.195 | 0.234 | 0.293 | 0.390 | 0.468 | 0.585 | 0.702 | 0.936 |
| 263 | 4 | X | X | X | X | X | X | X | X | X | X |
| | | <2B | <2B | <2B | <2B | <2B | <2B | <2B | <2B | <2B | <2B |
| 572 | 37 | X | X | X | X | X | X | X | X | X | X |
| | | <2B | <2B | <2B | <2B | <2B | <2B | <2B | <2B | <2B | <2B |
| 881 | 70 | Δ | Δ | Δ | Δ | Δ | Δ | Δ | Δ | Δ | Δ |
| | | 2B | 2B | 2B | 2B | 2B | B | HB | HB | HB | HB |
| 1191 | 104 | Δ | Δ | Δ | Δ | Δ | Δ | Δ | Δ | Δ | Δ |
| | | 2B | 2B | 2B | 2B | 2B | B | HB | HB | F | HB |
| 1500 | 137 | Δ | Δ | Δ | Δ | Δ | Δ | Δ | Δ | Δ | Δ |
| | | 2B | 2B | 2B | 2B | 2B | HB | F | F | HB | F |
| 1810 | 170 | Δ | Δ | Δ | Δ | Δ | Δ | Δ | Δ | Δ | Δ |
| | | B | B | B | B | HB | F | F | F | F | F |
| 2119 | 203 | Δ | Δ | ◯ | ◯ | ◯ | ◯ | ◯ | ◯ | ◯ | ◯ |
| | | B | B | HB | HB | HB | F | H | H | H | H |
| 2429 | 236 | Δ | Δ | ◯ | ◯ | ◯ | ◯ | ◯ | ◯ | ◯ | ◯ |
| | | B | HB | F | F | F | F | H | H | H | H |

TABLE 6

| | Quantity | | | | | | | | | | |
|---|---|---|---|---|---|---|---|---|---|---|---|
| Illuminance | of light | Output of heater (kW/cm) | | | | | | | | | |
| (mW/cm²) | (mJ/cm²) | 0.117 | 0.146 | 0.195 | 0.234 | 0.293 | 0.351 | 0.468 | 0.585 | 0.702 | 0.936 |
| 263 | 4 | X | X | X | X | X | X | X | X | X | X |
| | | <2B | <2B | <2B | <2B | <2B | <2B | <2B | <2B | <2B | <2B |
| 572 | 37 | X | X | X | X | X | X | X | X | X | X |
| | | <2B | <2B | <2B | B | B | B | B | B | B | B |
| 881 | 70 | Δ | Δ | Δ | Δ | Δ | Δ | Δ | Δ | Δ | Δ |
| | | 2B | 2B | HB | F | F | F | F | F | F | F |
| 1191 | 104 | Δ | Δ | Δ | ◯ | ◯ | ◯ | ◯ | ◯ | ◯ | ◯ |
| | | HB | F | F | H | H | H | H | H | H | H |
| 1500 | 137 | Δ | ◯ | ◯ | ◯ | ◯ | ◯ | ◯ | ◯ | ◯ | ◯ |
| | | F | F | H | H | H | H | H | H | H | H |
| 1810 | 170 | ◯ | ◯ | ◯ | ◯ | ◯ | ◯ | ◯ | ◯ | ◯ | ◯ |
| | | F | F | H | H | H | H | H | H | H | H |
| 2119 | 203 | ◯ | ◯ | ◯ | ◯ | ◯ | ◯ | ◯ | ◯ | ◯ | ◯ |
| | | F | F | H | H | H | H | H | H | H | H |
| 2429 | 236 | ◯ | ◯ | ◯ | ◯ | ◯ | ◯ | ◯ | ◯ | ◯ | ◯ |
| | | F | H | H | H | H | H | H | H | H | H |

As shown in Table 5, if the recording medium 2 is not subjected to preliminary heating, it is required, in order to secure a tack-free property of: “O”, that the illuminance and the quantity of light of the light-irradiating means 5 is set to not less than 2119 mW/cm² and not less than 203 mJ/cm², respectively, and the heater output of the heating means 6 is set to 0.195 KW/cm or more. Further, in order to secure the pencil hardness of “H” or more, it is required that the illuminance and the quantity of light of the light-irradiating means 5 is set to not less than 2119 mW/cm² and not less than 203 mJ/cm², respectively, and the heater output of the heating means 6 is set to 0.468 KW/cm or more. Thus, if the recording medium 2 is not subjected to preliminary heating, the appropriate conditions for obtaining excellently cured substance would be confined to a narrow range.

Whereas, if the recording medium 2 is subjected to preliminary heating at a temperature ranging from 35 to 120° C., it would be possible to greatly expand the aforementioned range of appropriate conditions as shown in FIG. 6. Namely, if it is desired to secure a tack-free property of: “O”, it is only required that the illuminance and the quantity of light of the light-irradiating means 5 is set to not less than 1191 mW/cm² and not less than 104 mJ/cm², respectively, and the heater output of the heating means 6 is set to 0.117 KW/cm or more. Further, if it is desired to secure the pencil hardness of “H” or more, it is only required that the heater output of the heating means 6 is set to 0.146 KW/cm or more.

As described above, it has been confirmed that when the surface temperature of the recording medium 2 is subjected to preliminary heating at a temperature of not lower than the temperature of the ink being delivered from the head 4, it is possible to greatly expand the appropriate conditions for curing as compared with the case where the recording medium 2 is not subjected to preliminary heating. In this example, the temperature (surface temperature) of the recording medium 2 was around 30° C., i.e., approximately the same as the normal temperature of the inkjet recording apparatus, and the temperature of the UV ink being delivered from the inkjet recording head 4 was about 40° C. As seen from the aforementioned results, it is possible to obtain sufficient effects by increasing the temperature (surface temperature) of the recording medium 2 by about 20° C., for example up to 50° C.

When it is compared with the conditions of irradiation being kept the same, even if the output of the heating means 6 is increased so as to make the peak temperature of the surface of recording medium 2 the same as each other, it would be impossible to expect any prominent effects. Namely, it is only possible, through the preliminary heating of the recording medium 2 so as to increase the surface temperature of recording medium 2 up to the same with or higher than the temperature of ink being delivered from the head 4, to promote the curing of ink. This cure-promoting effect can be realized even if the ultimate surface temperature of the recording medium 2 is the same.

As far as the illuminance and the quantity of light of the light-irradiating means 5 is set to not less than 1191 mW/cm² and not less than 104 mJ/cm², respectively, as the conditions for irradiation, it is possible to obtain the same cure-promoting effect as described above as long as the peak surface temperature of the recording medium 2 to be preliminarily heated by the recording medium temperature-controlling means 7 is confined within the range of 35 to 120° C. Although it would be more or less influenced by the temperature of the UV ink being delivered from the recording head 4, when the surface temperature of the recording medium 2 to be preliminarily heated by the recording medium temperature-controlling means 7 was made higher than the delivering temperature of the UV ink, it was possible to obtain excellent curing property as long as the temperature of preliminary heating was confined within the range of 35 to 120° C.

If the temperature of preliminary heating is lower than 35° C., it would be impossible to sufficiently obtain the effects of preliminary heating of the recording medium 2. On the other hand, if the temperature of preliminary heating is higher than 120° C., the recording medium 2, the UV ink and the inkjet recording apparatus 1 would be more likely damaged and, moreover, images to be formed on the recording medium 2 would be badly affected, generating an irregular image, etc. Further, the energy consumption of the apparatus to be employed for the preliminary heating would be increased, thus generating another problem.

If the temperature of the UV ink being delivered from the recording head 4 is about 40° C., it would be possible to obtain more excellent effects as far as the temperature of preliminary heating of the recording medium 2 by the recording medium temperature-controlling means 7 is confined within the range of 50 to 70° C. It has been confirmed that if the temperature of preliminary heating of the recording medium 2 by the recording medium temperature-controlling means 7 is confined within the range of about 50 to 70° C. in view of preventing damage to the quality of the image and recording medium 2, it is possible to obtain more excellent curing properties of the UV ink layer formed on the recording medium 2.

It is also possible to expect the following effects through the preliminary heating of the recording medium 2. For example, if the temperature of the UV ink is 40° C., it is possible to lower the viscosity of the ink by preliminary heating the recording medium 2 up to the range of 50 to 70° C. by the recording medium temperature-controlling means 7. When the viscosity of the ink is lowered to 20 mPa.s(cp) or less for example, the acid generated in the ink layer would be more effectively diffused, leading to the enhancement of curability of the ink layer. Furthermore, it is possible, through the lowering of viscosity of the ink, to enhance the wettability thereof with the surface of recording medium 2 and to enhance the adhesion between the cured layer and the surface of recording medium 2.

A total quantity of heat required for increasing the temperature of the UV ink or the recording medium 2 for securing the tack-free property “O” can be determined as follows. Namely, a PET sheet having a thickness of 100 μm is required to be increased in temperature from the initial temperature to a high temperature which is required at least for the curing thereof by using entire heating sources including the preliminary heating by the recording medium temperature-controlling means 7, the heating by the light-irradiating means 5 and heating by the heating means 6. Herein, the initial temperature of the PET sheet is 50° C. or so, and the temperature which is required at least for the curing thereof is 90° C. or so.

The material of the recording medium indirectly employed for the measurement of the surface temperature in the aforementioned example was PET, so that if the specific gravity (m) is assumed as being 1.3, and specific heat (c) is assumed as being 1.3 (J/g° C.), the quantity of heat Q required for raising the temperature thereof by about 40° C. (90-50° C.) per 1 g of PET can be calculated as follows based on Q=mct.
Q=1.3×1.3×40=67.6 J

If the thickness of the PET sheet is 100 am, a required quantity of heat Q′ per 1 cm² of the sheet can be represented by Q′=0.676 (J/cm²). Therefore, the minimum conditions required for the curing of the UV ink film on the recording medium 2 would be at least 1000 mW/cm² or so in illuminance, at least 100 mJ/cm² or so in quantity of light, and at least 0.676 J/cm² or so in quantity of heat.

However, if the thickness of the recording medium 2 is larger than 1 mm, a far large quantity of heat would be required for raising the temperature of the recording medium since the heat which is required for the curing of the ink film on the recording medium would diffuse in the direction of the thickness of the recording medium. Namely, it would be required to supply the ink film with a sufficient quantity of heat which is necessary for increasing the temperature of ink film from the initial temperature of the recording medium 2 (about 50° C.) to the temperature (about 90° C.) which is at least required for the curing thereof by using entire heating sources including the preliminary heating by the recording medium temperature-controlling means 7, the heating by the light-irradiating means 5 and heating by the heating means 6.

Further, the curing process of the UV ink according to this embodiment of the present invention depends largely on the chemically amplification mechanism of the ink. Namely, at first, when the ink is irradiated with electromagnetic radiation such as ultraviolet rays (irradiation of light), an acid is generated from the photo-acid generating agent in the UV ink and this acid then diffuse into the ink layer due to the heating of the ink layer, thus acting the acid as a catalyst for the cross-linking reaction of the ink layer. Due to this diffusion of the acid, it is now possible to enable the acid to penetrate even into the deep region of the ink layer to which the light is incapable of being transmitted due to the obstruction by the coloring materials for example, thus making it possible to promote the curing throughout an extensive region of the ink layer.

If a UV ink which is high in viscosity is to be employed, the UV ink is generally heated in the inkjet recording head 4 to lower the viscosity thereof in order to make the viscosity thereof optimal for the delivery thereof, thus adjusting the viscosity of the UV ink to an optimal viscosity. When the UV ink thus heated in the inkjet recording head 4 is ejected to reach the surface of the recording medium 2 which is lower in temperature than the UV ink, the UV ink is cooled, thereby increasing the viscosity of the UV ink. Therefore, even if the acid is subsequently generated from the photo-acid generating agent by the irradiation of electromagnetic radiation (irradiation of light), the acid is prevented from effectively diffusing into the ink layer. As a result, the curing efficiency of the ink layer is degraded, thus necessitating a large quantity of heat for the re-diffusion of the acid through the subsequent heating.

Therefore, it is desired that a maximum ultimate temperature of the surface of the recording medium on the occasion of heating the recording medium in the heating step after the irradiation of electromagnetic radiation to the layer of UV ink is higher than a maximum ultimate temperature of the surface the recording medium on the occasion of irradiating the electromagnetic radiation to the ink layer. In this case, the acid that has been generated from the photo-acid generating agent by the irradiation of light can be more effectively diffused, thus making it possible to further enhance the curing efficiency of the UV ink layer. The method according to this embodiment of the present invention makes it possible to realize the aforementioned effects through the preliminary heating of the recording medium.

According to one aspect of the present invention, there is provided a method of effectively curing an electromagnetic radiation-curing type liquid composition comprising a solvent which is polymerizable in the presence of an acid, and a photo-acid generating agent which is dissolved in the solvent and capable of generating the acid as it is irradiated with electromagnetic radiation.

According to another aspect of the present invention, there is provided an apparatus which is capable of discharging an electromagnetic radiation-curing type liquid composition by an inkjet so as to effectively perform recording, wherein the ink composition comprises a solvent which is polymerizable in the presence of an acid, and a photo-acid generating agent which is dissolved in the solvent and capable of generating the acid as it is irradiated with electromagnetic radiation.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A method of curing an electromagnetic radiation-curing type liquid composition comprising a solvent which is polymerizable in the presence of an acid, and a photo-acid generating agent which is dissolved in the solvent and capable of generating the acid as it is irradiated with electromagnetic radiation, the method comprising:
forming a layer of the electromagnetic radiation-curing type liquid composition on a recording medium; and
irradiating electromagnetic radiation including a wavelength which can be absorbed by the photo-acid generating agent onto the layer of the electromagnetic radiation-curing type liquid composition to generate the acid from the photo-acid generating agent, thereby curing the layer of the electromagnetic radiation-curing type liquid composition;
wherein the recording medium is heated on the occasion of forming the layer of the electromagnetic radiation-curing type liquid composition in such a manner that the temperature of the recording medium is increased higher than the temperature of the electromagnetic radiation-curing type liquid composition being delivered onto the recording medium.

2. The method according to claim 1, wherein the electromagnetic radiation-curing type liquid composition additionally contains pigment as a coloring component.

3. The method according to claim 1, wherein a maximum ultimate temperature of the surface of the recording medium after the irradiation of electromagnetic radiation to the layer of the electromagnetic radiation-curing type liquid composition is higher than a maximum ultimate temperature of the surface the recording medium on the occasion of irradiating the layer of the electromagnetic radiation-curing type liquid composition with the electromagnetic radiation.

4. The method according to claim 1, wherein a heat is applied to the layer of the electromagnetic radiation-curing type liquid composition formed on the recording medium, the heat being at least sufficient to cause a diffusion of the acid generated from the photo-acid generating agent included in the electromagnetic radiation-curing type liquid composition into the layer of the electromagnetic radiation-curing type liquid composition, thereby curing the layer of the electromagnetic radiation-curing type liquid composition.

5. The method according to claim 1, wherein the heating of the recording medium is performed by using a non-contact type heating means.

6. The method according to claim 1, wherein the recording medium is formed of a metallic substance.

7. An inkjet recording apparatus comprising:
a delivering means delivering an electromagnetic radiation-curing type liquid composition onto the recording medium by an inkjet recording head, the ink composition comprising a solvent which is polymerizable in the presence of an acid, and a photo-acid generating agent which is dissolved in the solvent and capable of generating the acid as it is irradiated with electromagnetic radiation;
a transferring means moving the recording medium and the inkjet recording head relative to each other;
a heat source heating the recording medium at least until the ink composition is delivered from the inkjet recording head; and
an irradiation source irradiating electromagnetic radiation including a wavelength that can be absorbed by the photo-acid generating agent to the electromagnetic radiation-curing type liquid composition that has been heated by the heat source.

8. The inkjet recording apparatus according to claim 7, wherein the electromagnetic radiation-curing type liquid composition additionally contains pigment as a coloring component.

9. The inkjet recording apparatus according to claim 7, wherein a maximum ultimate temperature of the surface of the recording medium after the irradiation of electromagnetic radiation to the layer of the electromagnetic radiation-curing type liquid composition is higher than a maximum ultimate temperature of the surface of the recording medium on the occasion of irradiating the layer of the electromagnetic radiation-curing type liquid composition with the electromagnetic radiation.

10. The inkjet recording apparatus according to claim 7, wherein the heat source applies a heat to the layer of the electromagnetic radiation-curing type liquid composition formed on the recording medium, the heat being at least sufficient to cause a diffusion of the acid generated from the photo-acid generating agent included in the electromagnetic radiation-curing type liquid composition into the layer of the electromagnetic radiation-curing type liquid composition, thereby curing the layer of the electromagnetic radiation-curing type liquid composition.

11. The inkjet recording apparatus according to claim 7, wherein the heating of the recording medium is performed by using a non-contact type heating means.

12. The inkjet recording apparatus according to claim 7, wherein the recording medium is formed of a metallic substance.
